(19) United States
(12) Patent Application Publication
(10) Pub. No.: US 2012/0296528 A1
(43) Pub. Date: Nov. 22, 2012

(54) Haptic steering wheel, steering-wheel system and driver assistance system for a motor vehicle

(76) Inventors: Matthias Marcus WELLHOEFER, Stuttgart (DE); Christian MOTZ, Ludwigsburg (DE)

(21) Appl. No.: 13/474,199

(22) Filed: May 17, 2012

(30) Foreign Application Priority Data
May 20, 2011 (DE) 10 2011 076 174.8

(51) Int. Cl. B60W 10/00; B62D 1/04; G06F 17/00

(52) U.S. Cl. 701/48; 74/552

(57) ABSTRACT

A steering wheel and a driver assistance system, which make possible an improved control of safety functions, driving functions and/or convenience functions of a vehicle. The steering wheel, in this context, has a plurality of touch-sensitive and which may be pressure-sensitive sensors on a steering-wheel rim. These sensors are to provide a grasp information signal, which indicates information on a contact surface, a position and/or a holding force of driver's hands on the steering-wheel rim, for instance, on a CAN bus. A driver assistance system uses these grasp information signals to adapt safety functions, driving functions and/or convenience functions, such as an automatic emergency brake assistant, power steering, a pedestrian avoidance assistant or a lane departure warning system in an adapted manner to the currently prevailing grasping type of the driver at the steering-wheel rim.

### RELATED APPLICATION INFORMATION

The present application claims priority to and the benefit of German patent application no. 10 2011 076 174.8, which was filed in Germany on May 20, 2011, the disclosure of which is incorporated herein by reference.

### FIELD OF THE INVENTION

The present invention relates to a steering wheel for a vehicle, as well as a steering-wheel system and a driver assistance system, in which information signals provided by the steering wheel are able to be used.

### BACKGROUND INFORMATION

Vehicles such as cars are typically steered by a driver's turning a steering wheel using his hands, and in this way controlling the steering angle of wheels of the vehicle. Using one or both hands, the driver grasps around a steering-wheel rim of the steering wheel, the steering-wheel rim usually being circular and being connected to a steering-wheel hub, which, in turn, is connected to a steering column.

It is also known that one may provide push-button switches or other switches on a steering wheel in the proximity of the steering-wheel rim, but not directly on the steering-wheel rim. With the aid of these push-button switches or other switches, a driver is able to control certain convenience comfort or safety functions of the vehicle, for example, without having to take his hands from the steering wheel. For instance, with the aid of the push-button switches or other switches, the volume of a car radio, a car phone or a cruise control may be controlled.

It is also known that one may equip motor vehicles with driver assistance systems, which control or support certain safety functions and/or convenience functions of the motor vehicle. Examples of such driver assistance systems are, among other things, an automatic emergency brake assistant, a power steering system, a pedestrian avoidance assistant and a lane departure warning system.

### SUMMARY OF THE INVENTION

It was recognized that, in modern motor vehicles, there may be a requirement for carrying out the functions of driver assistance systems even more safely and adapted to the driving situations.

Such a requirement is able to be covered using a steering wheel, a steering-wheel system and a driver assistance system according to the description herein. Further advantageous developments of the present invention are indicated in the further description herein.

According to a first aspect of the present invention, a steering wheel is proposed for a vehicle. At a steering-wheel rim, the steering wheel has a grasping area, at which the steering wheel is able to be grasped by the hands of the driver for steering the vehicle. Distributed over this grasping region, the steering wheel has a plurality of touch-sensitive sensors.

One aspect, in this connection, is to equip the region, in which a driver typically grasps the steering wheel with his hands while steering the vehicle, with a plurality of touch-sensitive sensors. The touch-sensitive sensors may be developed in such a way, in this instance, that with their aid it may be detected whether and where the driver is touching or grasping the steering wheel with his hands. For this purpose, the sensors may be pressure sensitive. In particular, the sensors may be developed as area sensors and/or be integrated into a circular tube-shaped geometry of the steering-wheel rim, that is typical for motor vehicles, in such a way that they do not interfere with the accustomed grasp of the steering-wheel rim by the driver. The sensors, in this instance, may make use of different technical implementations, which make possible touch sensitivity and which may also make possible pressure sensitivity. The sensors may, for instance, be outfitted with pressure-sensitive, capacitive elements, piezoelements, etc. The pressure-sensitive elements, in this instance, may be integrated into a planar element covering the steering-wheel rim, such as in the form of a thin film. The pressure sensitivity of the sensors may be dimensioned in such a way that various pressures, that are typically generated by a driver using his hands on a steering wheel, are able to be distinguished.

The sensors may be situated along the entire circumference of the steering-wheel rim, the distance between the centers of adjacent sensors being intended to be less than 2 cm, which may be less than 1 cm. In other words, the distance between the centers of adjacent sensors may be selected so that adjoining fingers of a driver, during normal grasping of the steering-wheel rim, operate different sensors. The sensors may be positioned, in this context, along the circumference of the steering-wheel rim in one or more rows. Adjacent sensors may border directly on one another, but there may also be an intermediate distance between adjacent sensors. A plurality of rows of sensors may be situated in a direction that is transverse to the circumferential direction of the steering-wheel rim, around a tube of the steering-wheel rim. Because of that, a part of, or the entire surface of the steering-wheel rim may be covered by a two-dimensional matrix of sensor elements.

The proposed steering wheel may be used in a steering wheel system that is configured to provide a grasp information signal, with the aid of touch-sensitive sensors of the steering wheel. In this context, the grasp information signal yields information on a contact surface of driver's hands in the grasping area, information on a position of driver's hands in the grasping area and/or information on a holding force of the driver's hands in the grasping area.

The grasp information signal may, for example, be provided to a CAN bus (controller area network) of the motor vehicle. In this way, the grasp information signal may be picked up by other systems of the motor vehicle and processed further. The grasp information signal may be provided as a digital or analog electric signal, in this instance.

The grasp information signal provided by the steering wheel system may be used particularly in a driver assistance system of a motor vehicle. The driver assistance system, in this instance, may be configured to condition functions for supporting or controlling safety functions, driving functions and/or convenience functions of the motor vehicle, based on the grasp information signal. By this conditioning one may understand that the safety functions, driving functions and/or convenience functions are influenced or carried out in different ways, as a function of the grasp information signal provided. In this context, one may utilize the fact that the grasp information signal supplies information on whether, where and how a driver is instantaneously grasping the steering wheel with his hands. Based on this information, triggering thresholds of safety functions or driving functions of the driver assistance system or working modes of the driver assistance system may be influenced.

The driver assistance system may be configured, for example, to control or support safety functions, driving functions and/or convenience functions to a greater extent when it is detected, by the use of the grasp information signal, that it is not possible for the driver to exert sufficient control on the safety functions, the driving functions and/or the convenience functions, based on the current state of grasp of his hands on the steering wheel. In other words, when the driver assistance system is able to detect, based on the grasp information signal, that the driver is grasping the steering wheel only insufficiently, i.e., for instance, only with one hand or in an unfavorable position, it is able to control automatically and support the safety functions, driving functions and/or convenience functions to a greater extent, so as make the operation of the steering wheel easier for the driver, or in order to counteract, in a compensating manner, the faulty operation of the steering wheel by the driver.

The driver assistance system may also be configured to emit a warning signal, as a function of the grasp information signal. The warning signal may, for instance, tell that a critical driving situation is threatening, so that the driver still has the possibility, in time, to get his hands sufficiently around the steering wheel.

The driver assistance system may also be configured to have an effect on a point in time of the automated supporting or controlling of safety functions, driving functions and/or convenience functions of the vehicle, as a function of the grasp information signal. The driver assistance system may, for instance, activate the safety functions earlier, when it is detected that the driver is grasping the steering wheel only insufficiently. In addition, a point in time, at which a warning signal is output, may be affected as a function of the grasp information signal, so that, for example, during an insufficient grasping of the steering wheel by the driver, such a warning signal is output earlier.

The driver assistance system may also be configured to have an effect on the type of an automated supporting or controlling of safety functions, driving functions and/or convenience functions of the vehicle, as a function of the grasp information signal. For instance, the type in which the driver assistance system supports or supplements steering activities of the driver, may be selected as a function of how the driver is grasping all around the steering wheel. In a supplementary manner, the type of how a warning signal is output may be influenced as a function of the grasp information signal. For example, in the case of sufficient grasping around a steering wheel, a warning signal may be passed on to the driver via haptically detectable signal transducers on the steering wheel, whereas in the case of insufficient grasping around a steering wheel, warning signals are generated that are acoustically or visually perceivable, in a supplementary or alternative manner.

Possible features and advantages of the exemplary embodiments and/or exemplary methods of the present invention are described herein partially with reference to specific embodiments of the steering wheel or the steering wheel system according to the exemplary embodiments and/or exemplary methods of the present invention, and partly with reference to a driver assistance system according to the present invention. However, one skilled in the art will recognize that the features described may both be combined with one another in different ways, and also transferred from the steering wheel or the steering wheel system to the driver assistance system or vice versa, in an analogous manner, in order thereby to achieve synergy effects, in particular.

Specific embodiments of the present invention are described below, with reference to the attached drawing, both the description and the drawing, however, not being interpretable as restricting the invention.

### BRIEF DESCRIPTION OF THE DRAWING

FIG. 1 shows a steering wheel and a driver assistance system according to specific embodiments of the present invention.

### DETAILED DESCRIPTION

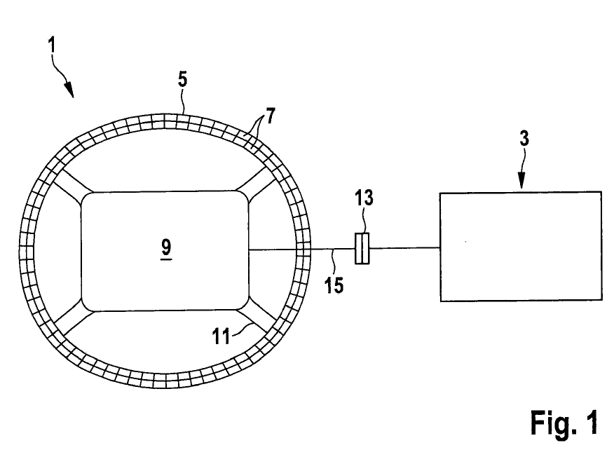

FIG. 1 shows a specific embodiment of a steering wheel 1 according to the exemplary embodiments and/or exemplary methods of the present invention. A steering-wheel rim 5 is connected via crosspieces 11 to a central part 9, which in turn collaborates with a steering column of a motor vehicle that is not shown.

Along a circumferential direction of steering-wheel rim 5 that is executed as a circular-shaped tube, a plurality of touch-sensitive and pressure-sensitive sensors 7 are integrated into steering-wheel rim 5 in matrix form. Sensors 7 are developed as planar elements, in this instance, which essentially cover the entire surface of steering-wheel rim 5. The size of sensors 7 and the distance between adjacent sensors 7 is selected in such a way, in this case, that in particular it can be detected whether steering-wheel rim 5 is being grasped by a driver, and if so, using how many hands and fingers and at which position the driver is grasping steering-wheel rim 5. In addition, based on the pressure sensitivity of sensors 7, it may be detected how firmly the driver is grasping around steering-wheel rim 5.

A corresponding grasp information signal is able to be supplied via a line 15 on a CAN bus 13 of the motor vehicle. A driver assistance system 3 connected to CAN bus 13 is able to read out the grasp information signals, and to use them for conditioning the safety functions, driving functions and/or convenience functions of the motor vehicle as a function of the grasp information signal. In this way, for example, autonomously intervening safety-relevant assistance and convenience systems, such as an automatic emergency brake assistant, a power steering, a pedestrian avoidance assistant or a lane departure warning system may be preconditioned, may be controlled, or its triggering thresholds may be changed, as a function of a current-time, instantaneous steering capability of the driver.

The steering capability of the driver is determined, in this context, with the aid of a contact surface, a number of contact points of hands and fingers, a pressure and a holding firmness and/or a position on the steering wheel.

In this way, in an advantageous manner, at least a part of the necessary safety, which is lost, for example, in that the driver does not firmly hold the steering wheel, is able to be produced again or at least improved via a targeted intervention in a logic or control of the assistance system.

If, for example, by the measurement on the steering wheel, a loose steering-wheel holding by the driver and/or a one-hand steering and/or a small contact surface and/or a low pressure of the hands is determined, or the steering wheel is not grasped around correctly or is being held at an unfavorable location, the steering wheel system and the driver assistance system is able to provide this grasp information to all relevant systems, for instance, via the CAN interface or other interfaces.

In embodiment variants of the present invention, the reaction may be, for instance, as follows:

In the case of the approach of an object and simultaneous loose steering-wheel holding, a collision warning may, for example, be output earlier, so that the driver still has enough time to grasp the steering wheel firmly, so as to be able to react in a suitable manner. Alternatively or additionally, automatic braking and braking support may be initiated earlier.

A similar reaction may also be carried out for automated avoiding.

In the case of lane departure warning systems, the warning may take place, at little to no steering wheel contact by the driver, at least additionally optically or acoustically, and perhaps one may do even totally without a haptic warning.

In danger zones, such as before a curve, if, based on information from navigational data it is detectable that the current speed of the vehicle is too great for the radius of the approaching curve, and if, in addition, too loose a steering-wheel holding is detected, a parameterization of the power steering may be changed, for example, so that the driver is then also able, on a short-term basis, to steer around the curve using the currently prevailing and detected hand contact surface.

The steering wheel, steering wheel system and driver assistance system may in this way contribute both to an increase in driving safety and perhaps even to an increase in driving convenience.

What is claimed is:

1. A steering wheel for a vehicle, comprising:
a steering-wheel rim having a grasping area thereon, at which the steering wheel is able to be grasped by the hands of a driver for steering the vehicle; and
a plurality of touch-sensitive sensors distributed over the grasping area.

2. The steering wheel of claim 1, wherein the touch-sensitive sensors are pressure-sensitive.

3. The steering wheel of claim 1, wherein the sensors are situated along the entire circumference of the steering-wheel rim, and wherein a distance between the centers of adjacent sensors is less than 2 cm.

4. A steering wheel system, comprising:
a steering wheel for a vehicle, including:
a steering-wheel rim having a grasping area thereon, at which the steering wheel is able to be grasped by the hands of a driver for steering the vehicle; and
a plurality of touch-sensitive sensors distributed over the grasping area;
wherein the steering wheel system is configured, with the aid of the touch-sensitive sensors of the steering wheel, to provide at least one of a grasp information signal which indicates information on a contact surface of the driver's hands on the grasping area, a position of the driver's hands on the grasping area, and a holding force of the driver's hands on the grasping area.

5. The steering wheel system of claim 4, wherein the grasp information signal is provided on a CAN bus of the motor vehicle.

6. A driver assistance system for a motor vehicle, comprising:
a driver assistance arrangement configured to condition functions for supporting or controlling safety functions, driving functions and/or convenience functions of the motor vehicle, based on a grasp information signal from a steering wheel system;
wherein the steering wheel system includes:
a steering wheel for a vehicle, including:
a steering-wheel rim having a grasping area thereon, at which the steering wheel is able to be grasped by the hands of a driver for steering the vehicle; and
a plurality of touch-sensitive sensors distributed over the grasping area;
wherein the steering wheel system is configured, with the aid of the touch-sensitive sensors of the steering wheel, to provide at least one of a grasp information signal which indicates information on a contact surface of the driver's hands on the grasping area, a position of the driver's hands on the grasping area, and a holding force of the driver's hands on the grasping area.

7. The driver assistance system of claim 6, wherein the driver assistance system is configured to control or to support safety functions, driving functions and/or convenience functions of the motor vehicle to a greater extent when, with the aid of the grasp information signal, it is detected that no sufficient controlling of the safety functions, the driving functions and/or the convenience functions is possible for the driver, based on the current grasping condition of his hands on the steering wheel.

8. The driver assistance system of claim 6, wherein the driver assistance system is configured to emit a warning signal, as a function of the grasp information signal.

9. The driver assistance system of claim 6, wherein the driver assistance system is configured to have an effect on a point in time of an automated supporting or controlling of safety functions, driving functions and/or convenience functions of the motor vehicle and/or a point in time of the output of a warning signal, as a function of the grasp information signal.

10. The driver assistance system of claim 6, wherein the driver assistance system is configured to have an effect on the type of an automated supporting or controlling of safety functions, driving functions and/or convenience functions of the motor vehicle and/or the type of the output of a warning signal, as a function of the grasp information signal.
